(19) United States
(12) Patent Application Publication
(10) Pub. No.: US 2016/0116063 A1
(43) Pub. Date: Apr. 28, 2016

(54) APPARATUS FOR REDUCING BLOW-BY GAS FOR VEHICLE AND CONTROLLING METHOD THEREOF

(71) Applicant: HYUNDAI MOTOR COMPANY, Seoul (KR)

(72) Inventors: Sang Ho LEE, Andong-si (KR); Jae Hwan SEOL, Seoul (KR)

(21) Appl. No.: 14/684,131

(22) Filed: Apr. 10, 2015

(30) Foreign Application Priority Data
Oct. 23, 2014 (KR) 10-2014-0144161

(51) Int. Cl. F16J 9/10; F02M 25/08

(52) U.S. Cl. CPC F16J 9/10; F02M 25/08

(57) ABSTRACT

An apparatus for reducing a blow-by gas for a vehicle includes an electromagnet disposed in a cylinder block of an engine and producing a magnetic field with respect to a piston when an electric current is applied thereto. An oil ring is inserted into an outer diameter of the piston to be expandable in an outer diameter direction of the piston by an absorption force of the electromagnet. A controller is controlled by an ECU and applies the electric current to the electromagnet.

### CROSS-REFERENCE(S) TO RELATED APPLICATION

The present application claims the benefit of priority to Korean Patent Application Number 10-2014-0144161 filed on Oct. 23, 2014, the entire contents of which application are incorporated herein for all purposes by this reference.

### TECHNICAL FIELD

The present disclosure relates to an apparatus for reducing a blow-by gas for a vehicle and a controlling method thereof, and more particularly, to an apparatus for reducing a blow-by gas for a vehicle and a controlling method thereof, which controls the blow-by gas that escapes through a gap between an inner wall of a cylinder and a piston to be reduced in an engine using an electromagnet.

### BACKGROUND

In a combustion engine, a blow-by gas is produced when an inner wall of an engine cylinder is worn out, and viscosity of an engine oil is decreased after a long period time due to engine reciprocation. There is a fine gap between the inner wall of the cylinder and an oil ring of a piston, through which the oil leaks out during an intake stroke of the engine and deposits on an air cleaner and a throttle valve of an intake system.

The blow-by gas contains the engine oil and impurities, and thus, the oil is consumed unnecessarily. Further carbon is deposited on a surge tank, the cylinder, and an exhaust system, thus contaminating them. Accordingly, a blow-by gas reduction device is required in a vehicle so as to reduce the blow-by gas.

A conventional blow-by gas reduction device includes a positive crankcase ventilation (PVC) valve, which is a one directional check valve, installed on an engine cylinder head and a breather hose for connecting a nipple, which is installed on a surge tank for the PVC valve to be connected, the cylinder head, and a throttle valve.

Accordingly, blow-by gas that is leaked to an oil fan through a gap between a cylinder block and a piston of an engine is introduced into the cylinder head and then is introduced into the surge tank through the PCV valve to be sent to a combustion chamber. When a pressure within the cylinder head is relatively high, the blow-by gas is introduced to the surge tank via an intake hose through the breather hose to be sent to the combustion chamber so as to be burnt. However, the blow-by gas reduction device is not proposed basically to reduce the blow-by gas and a separate control method is necessary so as to reduce the blow-by gas by controlling and maintaining the gap between the cylinder block and the piston in a case where an oil ring and a cylinder are worn out due to a long use of the engine.

The description provided above is a related art of the present inventive concept and is just for helping in understanding the background of the disclosure and should not be construed as being included in the related art known by those skilled in the art.

### SUMMARY

The present disclosure has been proposed to solve the above drawbacks, and an aspect of the present disclosure provides an apparatus for reducing a blow-by gas for a vehicle and a controlling method thereof capable of reducing the amount of blow-by gas by controlling and properly maintaining a gap between a cylinder block and a piston when an oil ring and a cylinder are worn out due to a long time use of an engine.

According to an exemplary embodiment of the present inventive concept, an apparatus for reducing a blow-by gas for a vehicle includes an electromagnet disposed in a cylinder block of an engine and producing a magnetic field with respect to a piston when an electric current is applied thereto. An oil ring is inserted into an outer diameter of the piston to be expandable in an outer diameter direction of the piston by an absorption force of the electromagnet. A controller is controlled by an electric control unit (ECU) and applies the electric current to the electromagnet.

A sensor is mounted to the cylinder block and measures an amount of the blow-by gas.

A pair of electromagnets may be provided in the cylinder block facing each other at an outer side of the cylinder.

The oil ring may have a sectional cut shape and generate an elastic recovery force when expanding outwardly.

The oil ring may have a sectional cut shape and a coil expander is inserted into an inner diameter surface of the oil ring.

According to another exemplary embodiment of the present inventive concept, a method of controlling an apparatus for reducing a blow-by gas for a vehicle includes
measuring an amount of the blow-by gas by a sensor when a vehicle starts and confirming whether the measured amount is within a permissible range of the blow-by gas that is set in an ECU. An output of an electromagnet provided on a cylinder block is controlled when it is confirmed that the measured amount is out of the permissible range of the blow-by gas.

The step of measuring the amount of the blow-by gas may be performed repeatedly when the measured amount is within the permissible range of the blow-by gas.

The output of the electromagnet may be increased in the step of controlling the output when the measured amount is greater than a maximum value of the permissible range.

The output of the electromagnet may be decreased in the step of controlling the output when the measured amount is smaller than a minimum value of the permissible range.

The step of measuring the amount of the blow-by gas may be performed repeatedly by measuring the amount of the blow-by gas and comparing the measured amount after the step of controlling the output of the electromagnet.

### BRIEF DESCRIPTION OF THE DRAWINGS

The above and other features of the present inventive concept will now be described in detail with reference to exemplary embodiments thereof illustrating the accompanying drawings which are given herein below by way of illustration only, and thus are not limitative of the present invention.

FIGS. 1-3 are views illustrating an apparatus for reducing a blow-by gas for a vehicle that is arranged on a cylinder according to an embodiment of the present inventive concept.

FIG. 4 is a view schematically illustrating a configuration of an apparatus for reducing a blow-by gas for a vehicle according to an embodiment of the present inventive concept

FIG. 5 is a flowchart illustrating a controlling method of an apparatus for reducing a blow-by gas for a vehicle according to an embodiment of the present inventive concept.

It should be understood that the appended drawings are not necessarily to s scale, presenting a somewhat simplified representation of various features of the present disclosure as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present inventive concept, examples of which are illustrated in the accompanying drawings and described below. While the invention will be described in conjunction with exemplary embodiments, it will be understood that present description is not intended to limit the invention to those exemplary embodiments. To the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general, such as passenger automobiles including: sports utility vehicles (SUV), buses, trucks, various commercial vehicles; watercraft including: a variety of boats and ships, aircraft, and the like, and includes hybrid vehicles, electric vehicles, plug-in hybrid electric vehicles, hydrogen-powered vehicles, and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, an apparatus for reducing a blow-by gas for a vehicle and a controlling method thereof according to exemplary embodiments of the present disclosure will be described with reference to the accompanying drawings.

The present disclosure is intended to provide an apparatus for blocking a blow-by gas by installing an electromagnet on a cylinder block through which a piston reciprocates and for eliminating a gap through which the blow-by gas leaks out in addition to a conventional blow-by gas reduction device including a PCV valve.

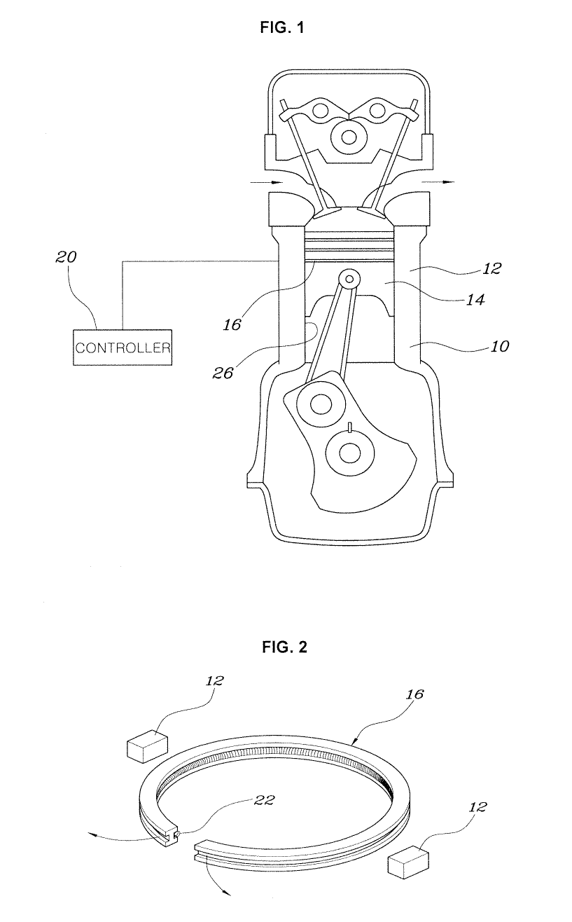

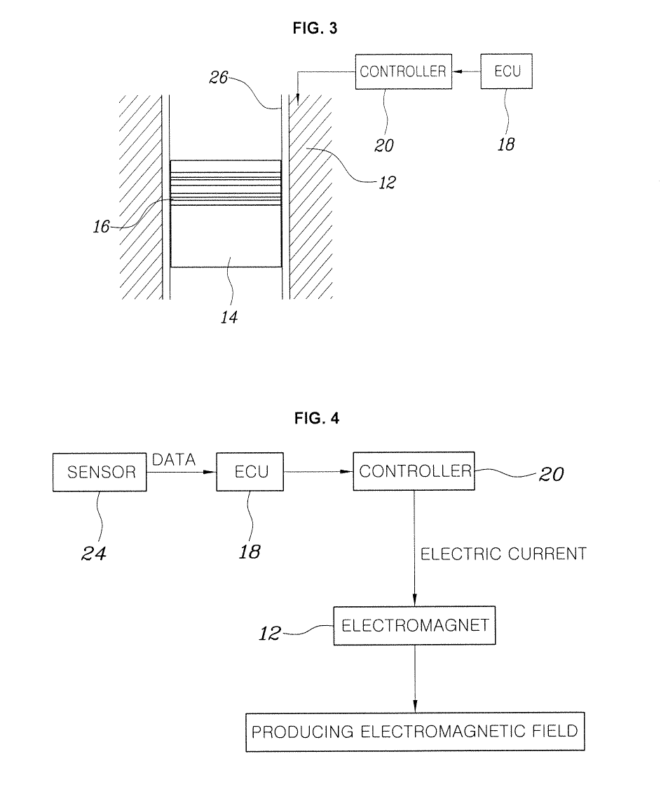

FIGS. 1-3 are views illustrating an apparatus for reducing a blow-by gas for a vehicle that is arranged on a cylinder according to an embodiment of the present inventive concept, and FIG. 4 is a view illustrating a configuration of an apparatus for reducing a blow-by gas for a vehicle according to an embodiment of the present inventive concept.

An apparatus for reducing a blow-by gas for a vehicle according to an embodiment of the present inventive concept includes an electromagnet 12 installed within a cylinder block 10 of an engine and producing a magnetic field with respect to a piston 14 when electric current is applied thereto. An oil ring 16 is inserted into an outer diameter surface of the piston 14 such that the oil ring 16 is expandable in an outer diameter direction of the piston 14 by an absorption force of the electromagnet 12. A controller 20 is controlled by an electric control unit (ECU) 18, whenever the controller applies the electric current to the electromagnet 12.

As shown in FIGS. 1 to 3, the electromagnet produces a magnetic field within the cylinder block 10 and exhibits the absorption force by the magnetic field with respect to the piston 14 when the electric current is applied. In more detail, electromagnet 12 as a pair are arranged facing each other on an outer part of a cylinder 26 within a cylinder block 10 so as to exhibit the absorption force by the magnetic field with respect to the piston 14.

The oil ring 16 is inserted in the outer diameter surface of the piston 14 so as to maintain an airtight seal with an inner wall of the cylinder 26. The oil ring 16 expands in the outer diameter direction of the piston 14 by the absorption force of the electromagnet 12. The oil ring 16 may have a cut shape at one part, wherein the oil ring has an elastic recovery force when it expands outwardly, or the oil ring may have the cut shape at the one part to expand to the outer diameter direction and may have a coil expander 22, which generates an elastic force, inserted into an inner diameter surface of the oil ring 16.

A sensor 24 may be provided on the cylinder block 10 so as to measure the amount of the blow-by gas and transfer the data to the ECU 18. The amount value of the blow-by gas that is measured by the sensor 24 is compared to a permissible range of the blow-by gas that is preset in the ECU 18, and, if necessary, the ECU operate the controller 20. Accordingly, the controller 20 allows the electromagnet 12 to produce the magnetic field by applying the electric current to the electromagnet 12 and to produce the absorption force with respect to the oil ring 16 of the piston 14 to thereby minimize a gap between the cylinder 26 and the oil ring 16.

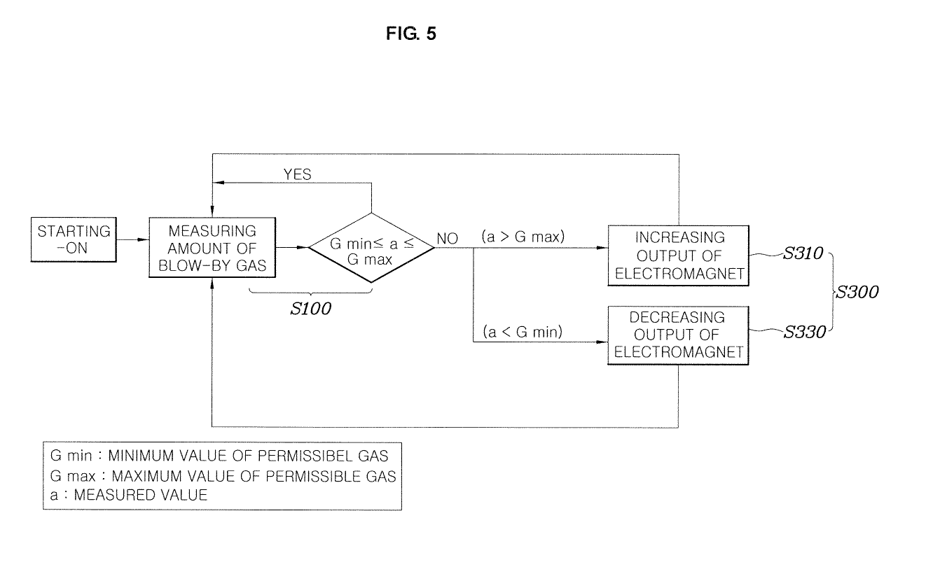

FIG. 5 is a flowchart illustrating a controlling method of an apparatus for reducing a blow-by gas for a vehicle according to an embodiment of the present inventive concept in which the controlling method of the apparatus for reducing a blow-by gas configured as described above.

A controlling method of an apparatus for reducing a blow-by gas for a vehicle according to an embodiment of the present inventive concept includes measuring the amount of blow-by gas by the sensor 24 when the vehicle starts and confirming whether the measured value is within a permissible range of the blow-by gas that is preset in an ECU 18 (S100). An output of an electromagnet 12 provided on a cylinder block 10 is controlled when it is confirmed that the measured value is not within the permissible range of the blow-by gas (S300).

When the vehicle starts, the amount of blow-gas is measured by the sensor 24 provided on the cylinder block 10, and the measured value is compared in the ECU 18 to determine whether it is within the permissible range of blow-by gas that is preset in the ECU 18.

The ECU 18 repeatedly measures the amount of blow-by gas when it is confirmed in the measured value comparison step S100 that the measured value is in the permissible range of blow-by gas. If it is confirmed that the measured value is not within the permissible range of blow-by gas, the ECU 18 performs the output control step S300 for controlling the output of the electromagnet 12 by controlling the controller 20.

When the measured value is greater than the maximum value of the permissible range of blow-by gas, an output increasing step S310 is performed for increasing the output of the electromagnet 12 through the controller 20. When the measured value is smaller than the minimum value of the permissible range of blow-by gas, an output decreasing step S330 is performed for decreasing the output of the electromagnet 12 in the output control step S300, thereby controlling the gap between the cylinder 26 and the oil ring 16.

Accordingly, the oil ring 16 expands toward an outer diameter direction, that is, toward an inner wall of the cylinder block 10 by an absorption force of the electromagnet 12 due to a cut shape of the oil ring 16, and a coil expander 22 being inserted into an inner diameter surface and generating an elastic force.

Further, the amount of blow-by gas is measured again in the output control step S300 after controlling the output of the electromagnet 12, and the measured value comparison step S100 for comparing the measured value in the ECU 18 is performed repeatedly in the ECU 18.

Thus, an expansion degree of the oil ring 160 is controlled while the oil ring 16 expands to the outer diameter direction according to a driving condition or a wearing degree of an engine to thereby maintain a gap between the cylinder 26 and the piston 14 as a constant level. Further, friction loss of the oil ring and the inner wall of the cylinder 26 can be reduced, and damage to the oil ring 16 can be prevented.

The oil ring 16 is in close contact with the inner wall of the piston 14 such that an airtight seal is maintained between the cylinder 26 and the piston 14 by reducing the gap therebetween. The inner wall of the cylinder 26 and the piston 24 are prevented from wearing out, being bonded, or being sintered due to an excessive close contact between the oil ring and the inner wall of the cylinder, and further, the blow-by gas does not escape from the combustion chamber.

According to the present disclosure, a leakage of the blow-by gas through the gap between the cylinder and the piston can be prevented or reduced using the electromagnet 12, and further, blow-by gas reducing effects can be maximized by using a conventional blow-by gas reducing device in combination with the apparatus and method of the present disclosure.

The disclosure has been described in detail with reference to an exemplary embodiment thereof. However, it will be appreciated by those skilled in the art that changes may be made in the embodiment without departing from the principles and spirit of the disclosure, the scope of which is defined in the appended claims and their equivalents.

What is claimed is:

1. An apparatus for reducing a blow-by gas for a vehicle, the apparatus comprising:
an electromagnet disposed n a cylinder block of an engine and producing a magnetic field with respect to a piston when an electric current is applied thereto;
an oil ring inserted into an outer diameter surface of the piston to be expandable in an outer diameter direction of the piston by an absorption force of the electromagnet; and
a controller controlled by an electric control unit (ECU), wherein the controller applies the electric current to the electromagnet.

2. The apparatus of claim 1, further comprising a sensor mounted to the cylinder block to measure an amount of the blow-by gas.

3. The apparatus of claim 1, wherein a pair of electromagnets are provided within the cylinder block facing each other at an outer side of the cylinder.

4. The apparatus of claim 1, wherein the oil ring has a sectional cut shape and generates an elastic recovery force when expanding outwardly.

5. The apparatus of claim 1, wherein the oil ring has a sectional cut shape and a coil expander is inserted in an inner diameter surface of the oil ring.

6. A method of controlling an apparatus for reducing a blow-by gas for a vehicle, the method comprising steps of:
measuring an amount of the blow-by gas by a sensor when a vehicle starts and confirming whether the measured amount is within a permissible range of the blow-by gas that is set in an ECU; and
controlling an output of an electromagnet disposed in a cylinder block when it is confirmed that the measured amount is out of the permissible range.

7. The method of claim 6, wherein the step of measuring the amount of the blow-by gas is performed repeatedly when the measured amount is within the permissible range.

8. The method of claim 6, wherein the step of controlling the output of the electromagnet comprises: a step of increasing the output of the electromagnet when the measured amount is greater than a maximum value of the permissible range.

9. The method of claim 6, wherein the step of controlling the output of the electromagnet comprises: a step of decreasing the output of the electromagnet when the measured amount is smaller than a minimum value of the permissible range.

10. The method of claim 6, wherein, in the step of controlling the output, the step of measuring the amount of the blow-by gas is performed repeatedly by measuring the amount of the blow-by gas and comparing the measured amount after the step of controlling the output of the electromagnet.
